(19) United States
(12) Patent Application Publication
(10) Pub. No.: US 2006/0274141 A1
(43) Pub. Date: Dec. 7, 2006

(54) Laser scan unit and an image forming apparatus having the same

(75) Inventors: Chul-hyun Park, Seoul (KR); Hyung-soo Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/398,690

(22) Filed: Apr. 6, 2006

(30) Foreign Application Priority Data
Jun. 3, 2005 (KR) 2005-0047822

(51) Int. Cl. G03G 15/01

(52) U.S. Cl. 347/118

(57) ABSTRACT

A laser scan unit for projecting lights to first through fourth image carrying mediums that are sequentially disposed includes first and second deflection scanning optical systems. The first deflection scanning optical system deflectively reflects a plurality of incident lights in respectively different directions toward the first and the third image carrying mediums. The second deflection scanning optical system defectively reflects a plurality of incident lights in respectively different directions toward the second and the fourth image carrying mediums. The first and the second deflection scanning optical systems are disposed at different distances with respect to a reference axis substantially perpendicular to a direction in which lights are projected to the respective image carrying mediums.

### CROSS-REFERENCE TO RELATED APPLICATIONS

This application claims the benefit under 35 U.S.C. § 119(a) of Korean Patent Application No. 2005-47822, filed Jun. 3, 2005, the entire contents of which are hereby incorporated by reference.

### BACKGROUND OF THE INVENTION

1. Field of the Invention

The present invention relates to a laser scan unit and an image forming apparatus having the same.

2. Description of the Related Art

Generally, image forming apparatuses are divided into a dry-type image forming apparatus that uses a powdery developer, such as toner, and a wet-type image forming apparatus that uses a liquid developer, which is a mixture of the toner and a liquid carrier.

The wet-type image forming apparatus is divided into mono-image forming apparatuses for implementing monochromatic images and color image forming apparatuses for implementing color images. Generally, wet-type color image forming apparatuses produce the color image using developers of various colors, such as magenta, cyan, yellow, and black.

As is generally known, the wet-type image forming apparatus forms an electrostatic latent image on an image carrying medium electrified by a charging unit by a light projected from a laser scan unit. The electrostatic latent image is developed by the developer into a visible image, and the visible image is transferred onto a printing medium. For the color image forming apparatus, respective color images are developed on image carrying mediums for the respective colors by color developers and then are overlappingly transferred onto an intermediate transfer belt (ITB). The overlapped color image on the ITB is transferred and fixed onto the printing medium, and the printing medium is discharged to the outside of the image forming apparatus.

The respective color images developed on the image carrying mediums for the respective colors may be transferred directly onto the printing medium in the overlapping manner without passing through the ITB, and then fixed on the printing medium by the fixing process.

In the above color image forming apparatus, however, the plurality of image carrying mediums require a large mounting space, thereby increasing the whole size of the image forming apparatus. Regarding the laser scan unit, adoption of a plurality of light sources for independent projection of the lights to the plurality of image carrying mediums induces complicated structure and a large size for the resulting image forming apparatus.

FIG. 1A and FIG. 1B illustrate a conventional laser scan unit as disclosed in Japanese Patent Publication No. 2004-226884.

Referring to FIGS. 1A and 1B, the conventional laser scan unit includes a casing 10 having three chambers 11, 12 and 13, a first scanning optical system 20 mounted in the chambers 11 and 13 formed at opposite sides in the casing 10, and a second scanning optical system 30.

The first and the second scanning optical systems 20 and 30 are symmetrically disposed with the chamber 12 therebetween to project light to first through fourth image carrying mediums 1, 2, 3 and 4 arranged at certain intervals. The first scanning optical system 20 projects a light by two light sources 21 and 22 mounted in the casing 10, respectively. The projected lights are incident to a specular surface of a polygonal mirror 24 rotated by a driving part 23, passing through a predetermined path. The incident lights are converted to deflected lights B1 and B2 and advance in opposite directions to each other with respect to the polygonal mirror 24. The deflected lights B1 and B2 pass through f·θ lenses 25 and 26 disposed on opposite sides of the polygonal mirror 24 and change the optical paths thereof from reflective mirrors 27 and 28, thereby being projected respectively to the image carrying mediums 1 and 2. Accordingly, an electrostatic latent image corresponding to a predetermined image is formed on the image carrying mediums 1 and 2.

The second scanning optical system 30 forms the electrostatic latent image on the other two image carrying mediums 3 and 4 by projecting light using a single polygonal mirror 34, through the same structure as the first scanning optical system 20.

In the conventional laser scan unit having the above structure, the two polygonal mirrors 24 and 34 are disposed at the same height to operate on the four image carrying mediums 1 through 4. Herein, to avoid interference between deflected lights B2 and B3 being reflected from the respective polygonal mirrors 24 and 34 toward the chamber 12 disposed at the center portion, the chamber 12 is provided to isolate the first and the second scanning optical systems 20 and 30 from each other. However, the isolating chamber 12 dedicatedly formed between the two scanning optical systems 20 and 30 increases the lateral size of the casing 10, thereby deteriorating compactness of the product of the image forming apparatus.

Accordingly, a need exists for an image forming apparatus having an improved laser scan unit that substantially prevents interference between projected lights without increasing the size of the laser scan unit.

### SUMMARY OF THE INVENTION

Accordingly, an aspect of the present invention is to provide a laser scan unit capable of implementing a compact size thereof, while preventing interference between projected lights, and an image forming apparatus having the same.

A laser scan unit is provided for projecting lights to first through fourth image carrying mediums that are sequentially disposed. A first deflection scanning optical system defectively reflects a plurality of incident lights in respectively different directions toward the first and the third image carrying mediums. A second deflection scanning optical system deflectively reflects a plurality of incident lights in respectively different directions toward the second and the fourth image carrying mediums. The first and the second deflection scanning optical systems are disposed at different distances with respect to a reference axis substantially perpendicular to a direction of projecting the lights to the respective image carrying mediums.

The first deflection scanning optical system includes first and second light sources projecting first and second lights, respectively. A first polygonal mirror deflectively reflects the first and the second lights in different directions. A first driving motor rotates the first polygonal mirror. A first optical guide guides the first light defectively reflected from the first polygonal mirror toward the first image carrying medium. A second optical guide guides the second light defectively reflected from the polygonal mirror toward the third image carrying medium.

The first optical guide comprises a first f·θ lens mounted on an optical path between the first polygonal mirror and the first image carrying medium. A plurality of first reflection mirrors are mounted on an optical path between the first f·θ lens and the first image carrying medium.

The plurality of first reflection mirrors include two first reflection mirrors. One first reflection mirror is disposed at the same distance as the first f·θ lens and the first polygonal mirror with respect to the reference axis. The other first reflection mirror is disposed at a further distance than the one first reflection mirror with respect to the reference axis.

The second optical guide includes a second f·θ lens mounted on an optical path between the first polygonal mirror and the third image carrying medium. A second reflection mirror is mounted on an optical path between the second f·θ lens and the third image carrying medium.

The second deflection scanning optical system includes third and fourth light sources projecting third and fourth lights. A second polygonal mirror defectively reflects the third and the fourth lights in different directions. A second driving motor rotates the second polygonal mirror. A third optical guide guides the third light deflectively reflected from the second polygonal mirror toward the second image carrying medium. A fourth optical guide guides the fourth light deflectively reflected from the second polygonal mirror toward the fourth image carrying medium.

The third optical guide includes a third f·θ lens mounted on an optical path between the second polygonal mirror and the second image carrying medium. A third reflection mirror is mounted on an optical path between the third f·θ lens and the second image carrying medium.

The fourth optical guide includes a fourth f·θ lens mounted on an optical path between the second polygonal mirror and the fourth image carrying medium. A fourth reflection mirror is mounted on an optical path between the fourth f·θ lens and the fourth image carrying medium.

The first and the second optical guides are disposed at substantially the same distance from the reference axis.

The second deflection scanning optical system includes third and fourth light sources projecting third and fourth lights. A second polygonal mirror defectively reflects the third and the fourth lights in different directions. A second driving motor rotates the second polygonal mirror. A third optical guide guides the third light deflectively reflected from the second polygonal mirror toward the second image carrying medium. A fourth optical guide guides the fourth light defectively reflected from the second polygonal mirror toward the fourth image carrying medium.

The third and the fourth optical guides are disposed at different distances from the first and the second optical guides with respect to the reference axis.

The third and the fourth optical guides are disposed further from the reference axis than the first and the second optical guides.

The first and the second driving motors are disposed at different distances from the reference axis.

The first and the second driving motors are symmetrically disposed at approximately 180° to one another.

The first through fourth image carrying mediums are arranged with substantially uniform intervals therebetween.

The first deflection scanning optical system is disposed nearer to the reference axis than the second deflection scanning optical system.

According to another aspect of the present invention, an image forming apparatus includes first through fourth image carrying mediums sequentially arranged substantially parallel with a predetermined reference axis. A laser scan unit projects lights to the first through fourth image carrying mediums in a direction substantially perpendicular to the reference axis, respectively. The laser scan unit includes a first deflection scanning optical system defectively reflecting a plurality of incident lights in respectively different directions toward the first and the third image carrying mediums. A second deflection scanning optical system deflectively reflects a plurality of incident lights in respectively different directions toward the second and the fourth image carrying mediums. The first and the second deflection scanning optical systems are disposed at different distances with respect to a reference axis substantially perpendicular to a direction in which the lights are projected to the respective image carrying mediums.

Other objects, advantages, and salient features of the invention will become apparent from the detailed description, which, taken in conjunction with the annexed drawings, discloses preferred exemplary embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1A is a plan view schematically showing a conventional laser scan unit;

FIG. 1B is a sectional view of the conventional laser scan unit of FIG. 1A;

FIG. 2 is a schematic illustration of an image forming apparatus according to an exemplary embodiment of the present invention;

FIG. 3 is a sectional view of a laser scan unit of FIG. 2; and

FIG. 4 is a plan view schematically showing the laser scan unit of FIG. 3.

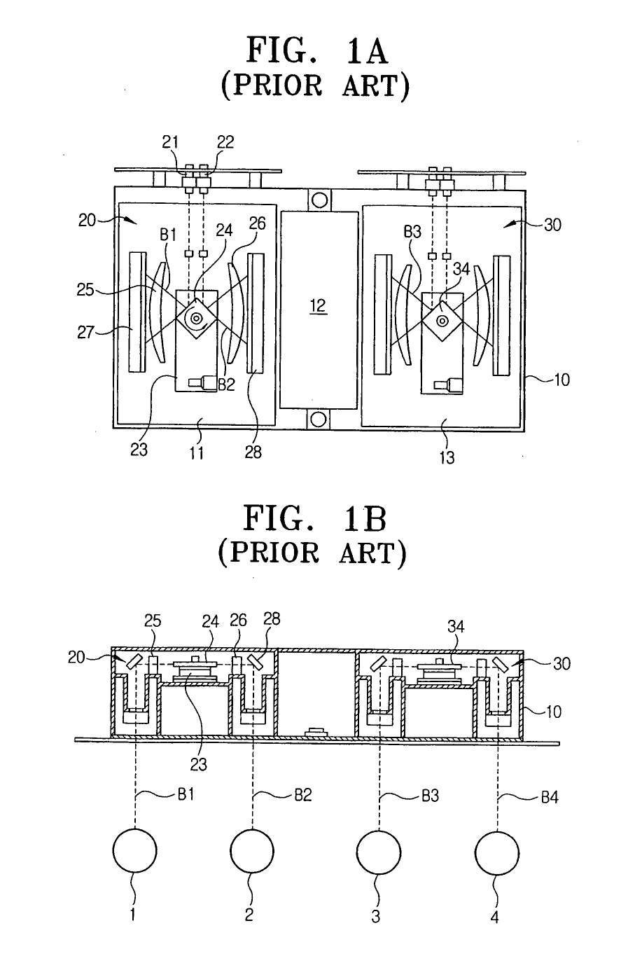

Throughout the drawings, like reference numerals will be understood to refer to like parts, components and structures.

### DETAILED DESCRIPTION OF EXEMPLARY EMBODIMENTS

Hereinafter, an exemplary embodiment of the present invention is described in detail with reference to the accompanying drawing figures.

The matters defined in the description, such as a detailed construction and elements thereof, are provided to assist in a comprehensive understanding of the present invention. Thus, it is apparent that the present invention may be carried out without those defined matters. Also, well-known functions or constructions are not described in detail to provide a clear and concise description of exemplary embodiments of the present invention.

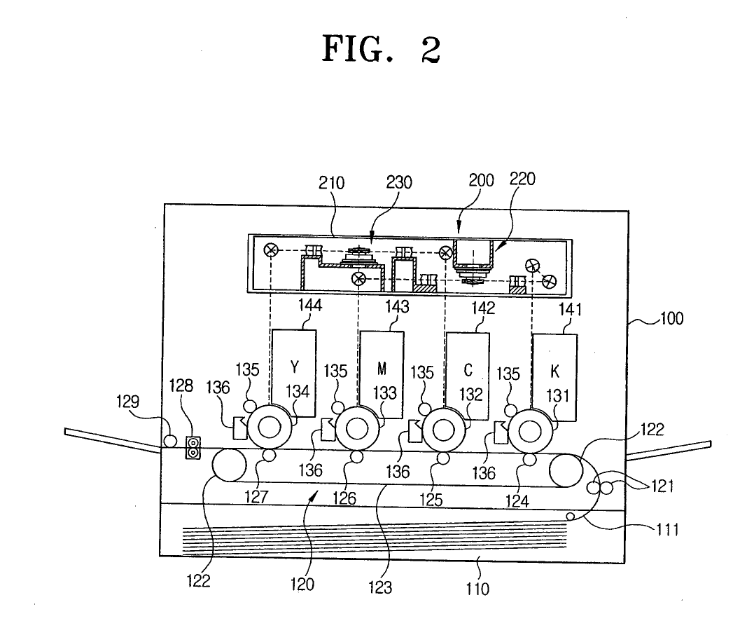

Referring to FIG. 2, an image forming apparatus according to an exemplary embodiment of the present invention includes a main body 100 and a paper supply unit 110 disposed at a lower part of the main body 100. A paper feeding unit 120 feeds a printing medium 111 supplied from the paper supply unit 110. First through fourth image carrying mediums 131, 132, 133 and 134 overlappingly transfer color images on the printing medium 111 fed by the paper feeding unit 120. First through fourth developing units 141, 142, 143 and 144 form the color images on electrostatic latent image areas formed on the image carrying mediums 131, 132, 133 and 134. A laser scan unit 200 forms the electrostatic latent image by projecting light on the respective image carrying mediums 131, 132, 133 and 134.

The paper feeding unit 120 includes a registration roller 121 for arranging leading ends of the printing medium 111 supplied from the paper supply unit 110. A conveying belt 123 supportingly guides the arranged printing medium 111 to pass through the respective image carrying mediums 131 to 134. The conveying belt 123 moves along a caterpillar being supported by a plurality of support rollers 122 and thereby guides the printing medium 111 to the respective image carrying mediums 131 to 134 in sequence. First through fourth transfer rollers 124, 125, 126 and 127 are correspond to the image carrying mediums 131 to 134 with the conveying belt 123 between the transfer rollers 124 to 127 and the image carrying mediums 131 to 134 to efficiently transfer the color images formed on the respective image carrying mediums 131 to 134 onto the printing medium 111.

In FIG. 2, a fixing unit 128 fixes the color image overlappingly transferred through the respective image carrying mediums 131 to 134 onto the printing medium 111 by heat and pressure. A discharge roller 129 ejects the printing medium 111 passed through the fixing unit 128 to the outside of the main body 100.

The respective image carrying medium 131 to 134 are arranged in sequence along a feeding path of the printing medium 111. In this exemplary embodiment, the first through the fourth image carrying mediums 131 to 134 are disposed at substantially uniform intervals and at substantially the same height. Also, the image carrying mediums 131 to 134 of the exemplary embodiment are configured to overlappingly transfer the color images in order of black, cyan, magenta and yellow with respect to the feeding path of the printing medium 111.

The respective image carrying mediums 131 to 134 perform electrifying, exposing, developing, transferring and cleaning along their rotational directions, according to a generally-known electrophotographic developing method. To this end, a charging roller 135 for electrifying surfaces of the respective image carrying mediums 131 to 134 and a cleaning member 136 for cleaning the surfaces of the image carrying mediums 131 to 134 are mounted adjacent to each of the image carrying mediums 131 to 134.

As being electrified by the charging roller 135 and exposed to the light projected from the laser scan unit 200, the image carrying mediums 131 to 134 are formed with the electrostatic latent image thereon.

The developing units 141 through 144 are arranged in corresponding number and position to the image carrying mediums 131 through 134 to develop color developer on the electrostatic latent image area of the image carrying mediums 131 through 134. Because the developing principle using the developing units 141 through 144 is well-known in the art, detailed description thereof is omitted.

The laser scan unit 200 projects light on the respective image carrying mediums 131 through 134 and is disposed at an upper part of the developing units 141 through 144 in this exemplary embodiment.

The laser scan unit 200 includes a plurality of deflection scanning optical systems, for example, two in this exemplary embodiment. The respective deflection scanning optical systems defectively project the lights. Therefore, the laser scan unit 200 is equipped with a scanning structure to project the lights corresponding to the first through the fourth image carrying mediums 131 to 134.

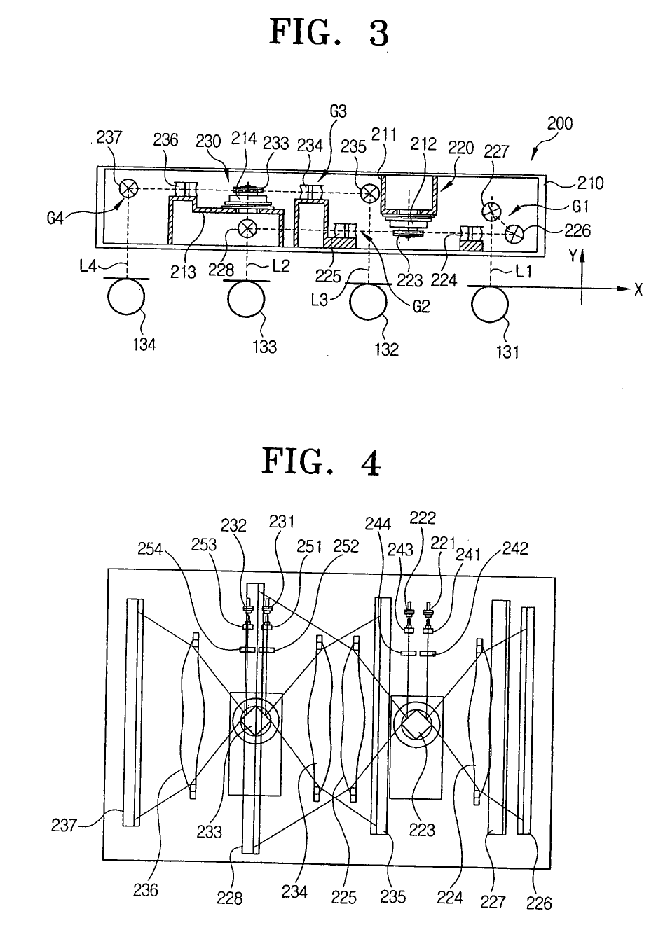

Referring to FIGS. 3 and 4, the laser scan unit 200 includes first and second deflection scanning optical systems 220 and 230 mounted in a scanner main body 210.

The scanner main body 210 is formed as a cabinet or a housing that mounts therein a variety of optical members that will be hereinafter described. Preferably, the scanner main body 210 has a cover to prevent foreign substances from flowing thereinto.

The first and the second deflection scanning optical systems 220 and 230 are disposed at different distances from a predetermined reference axis that is substantially perpendicular to a y-axis substantially parallel with a laser scanning direction. The reference axis will be referred to as the ‘x-axis’ hereinbelow.

The first deflection scanning optical system 220 independently projects first and second lights L1 and L2 onto the first and the third image carrying mediums 131 and 133, respectively. The first deflection scanning optical system 220 includes first and second light sources 221 and 222, a first polygonal mirror 223, and a first driving motor 212, as shown in FIGS. 3 and 4. A first optical guide G1 guides the first light L1 deflectively reflected from the first polygonal mirror 223 to the first image carrying medium 131. A second optical guide G2 guides the second light L2 defectively reflected from the first polygonal mirror 223 to the third image carrying medium 133. Deflectively reflecting and deflecting are used interchangeably throughout the detailed description.

The first and the second light sources 221 and 222 are implemented by laser diodes projecting the first and the second lights L1 and L2 substantially parallel toward the first polygonal mirror 223, as shown in FIG. 4. The first and the second light sources 221 and 222, being supported by the scanner main body 210 and controlled by a control unit to be turned on and off, project the lights to the first and the third image carrying mediums 131 and 133, respectively.

A first collimating lens 241 and a first cylinder lens 242 are arranged in order on an optical path between the first light source 221 and the first polygonal mirror 223. The first collimating lens 241 converts the first light L1 to a parallel light or a convergent light with respect to the optical axis. A slit (not shown) formed on a front of the first collimating lens restricts the light passing through the first collimating lens 241. Light passed through the first collimating lens 241 is incident to a specular surface of the first polygonal mirror 223 by passing through the first cylinder lens 242. The first light L1 passed through the first cylinder lens 242 is therefore incident to one side (the right side in FIG. 4) of the first polygonal mirror 223.

A second collimating lens 243 and a second cylinder lens 244 are mounted on an optical path between the second light source 222 and the first polygonal mirror 223. The second light L2 projected from the second light source 222 and passed through the second collimating lens 243 and the second cylinder lens 244 is incident to the other side (the left side in FIG. 4) of the first polygonal mirror 223.

The first polygonal mirror 223 is used in common to defectively project the first and the second lights L1 and L2 being independently projected from the first and the second light sources 221 and 222 respectively to the first and the third image carrying mediums 131 and 133. Therefore, the first polygonal mirror 223 is disposed on the optical path of the first and the second lights L1 and L2 and at a position where the two lights L1 and L2 are incident in opposite directions with respect to the rotational center thereof. Therefore, the first and the second lights L1 and L2 incident to the first polygonal mirror 223 are defectively projected in the opposite directions from each other. The first polygonal mirror 223 is mounted to be rotated at a high speed by the first driving motor 212 supported by a first support part 211 in the scanner main body 210. In this exemplary embodiment, the first driving motor 212 is mounted upside down with respect to a second driving motor 214 that will be described hereinafter, so that the first polygonal mirror 223 and a second polygonal mirror 233, which is described hereinafter, are disposed at different distances from the x-axis, thereby reducing the thickness of the scanner main body 210. The effects of such an arrangement of the polygonal mirrors 223 and 233 is described more specifically hereinafter.

The first optical guide G1 comprises a first f·θ lens 224 and first reflection mirrors 226 and 227.

The first f·θ lens 224 and the first reflection mirrors 226 and 227 are disposed on the optical path of the first light L1 being defectively reflected from the first polygonal mirror 223 to polarize the first light L1 into the first image carrying medium 131 and to compensate aberrations. The first reflection mirrors 226 and 227 guide the optical path of the first light L1 at different heights from each other and extend the length of the optical path, thereby equalizing the optical path from the first polygonal mirror 223 to the first image carrying medium 131 with optical paths of the other lights L2, L3 and L4 without having to distance the second image carrying medium 132 away from the first image carrying medium 131. The first image carrying medium 131 may be disposed at the same height as the other image carrying mediums 132 through 134. Therefore, the first f lens 224 and the one first reflection mirror 226 are disposed at substantially the same distance from the x-axis, and the other first reflection mirror 227 is disposed further from the x-axis than the first f·θ lens 224 and the one first reflection mirror 226.

The second optical guide G2 includes a second f·θ lens 225 and a second reflection mirror 228. Because the second light L2 is projected in the opposite direction to the first light L1, the second f·θ lens 225 and the second reflection mirror 228 are disposed symmetrically with the first f·θ lens 224 and the first reflection mirrors 226 and 227 with respect to the x-axis. The second f·θ lens 225 and the second reflection mirror 228 are disposed at substantially the same distance from the x-axis. Additionally, the second reflection mirror 228 is disposed corresponding to the third image carrying medium 133 to guide the second light L2 to the third image carrying medium 133.

The second deflection scanning optical system 230 projects the third and the fourth lights L3 and L4 onto the second and the fourth image carrying mediums 132 and 134. Being disposed proximal one another, the first and the second deflection scanning optical systems 220 and 230 are arranged so that the component parts thereof are partly alternated with each other with respect to the x-axis, thereby reducing width of the laser scan unit 200. Consequently, mounting space for the first thorugh the fourth image carrying mediums 131 through 134 may be reduced.

More specifically, the second deflection scanning optical system 230 includes third and fourth light sources 231 and 232, a second polygonal mirror 233, and a second driving motor 214, as shown in FIGS. 3 and 4. A third optical guide G3 is mounted on an optical path between the second polygonal mirror 233 and the second image carrying medium 132. A fourth optical guide G4 is mounted on the optical path between the second polygonal mirror 233 and the fourth image carrying medium 134.

The third light source 231 is implemented by a laser diode that projects the third light L3 to the second polygonal mirror 233 to scan the second image carrying medium 132. The fourth light source 232 is implemented by a laser diode that projects the fourth light L4 for scanning of the fourth image carrying medium 134 to the second polygonal mirror 233. On an optical path between the third light source 231 and the second polygonal mirror 233, a third collimating lens 251 and a third cylinder lens 252 are mounted. A fourth collimating lens 253 and a fourth cylinder lens 254 are mounted on an optical path between the fourth light source 232 and the second polygonal mirror 233.

The second polygonal mirror 233, being supported by the second driving motor 214, rotates at a high speed. The second driving motor 214 is supported by a second support part 213 mounted in the scanner main body 210. According to an exemplary embodiment, the second driving motor 214 and the first driving motor 212 are symmetrically positioned by approximately 180°, as shown in FIG. 3. Accordingly, the second polygonal mirror 233 is disposed further from the x-axis than the second driving motor 214 while the first polygonal mirror 223 is disposed nearer the x-axis than the first driving motor 212. The first and the second polygonal mirrors 223 and 233 are at different distances with respect to the x-axis.

The third light L3 is defectively reflected from the second polygonal mirror 233 to one side, that is, toward the first polygonal mirror 223 in this exemplary embodiment. After being deflected, the third light L3 is guided by the third optical guide G3 to the second image carrying medium 132.

The third optical guide G3 includes a third f·θ lens 234 mounted on an optical path between the second polygonal mirror 233 and the second image carrying medium 132, and a third reflection mirror 235. The third light L3 passed through the third f·θ lens 234 is reflected from the third reflection mirror 235 to the second image carrying medium 132. The third f·θ lens 234 and the third reflection mirror 235 are disposed at substantially the same height as the second polygonal mirror 233, that is, the at substantially the same distance from the x-axis. The third reflection mirror 235 is disposed to correspond to the second image carrying medium 132. Therefore, the second polygonal mirror 233, the third f·θ lens 234 and the third reflection mirror 235 are disposed higher than the first polygonal mirror 223, the second f·θ lens 225 and the second reflection mirror 228, respectively, in other words, at different distances with respect to the x-axis. Thus, although the second and the third lights L2 and L3 are defectively reflected from their respective polygonal mirrors 223 and 233 in opposite directions to each other, interference between the second and the third lights L2 and L3 is substantially prevented.

The fourth light L4 deflectively reflected from the second polygonal mirror 233 is guided by the fourth optical guide G4 to the fourth image carrying medium 134. The fourth optical guide G4 includes a fourth f·θ lens 236 mounted on an optical path between the second polygonal mirror 233 and the fourth image carrying medium 134, and a fourth reflection mirror 237. The fourth light L4 passed through the fourth f·θ lens 236 is reflected from the fourth reflection mirror 237 toward the fourth image carrying medium 134. Therefore, the fourth reflection mirror 237 is disposed to correspond to the fourth image carrying medium 134 in a direction of the y-axis. The fourth reflection mirror 237, the fourth f·θ lens 236, and the second polygonal mirror 233 are disposed at substantially the same distance with respect to the x-axis. Therefore, the fourth light L4 and the second light L2 may be substantially prevented from interfering with each other.

Referring to FIG. 4, the one first reflection mirror 226 and the second reflection mirror 228 are disposed at substantially the same distance from the x-axis but at different distances from the first polygonal mirror 223. Therefore, to ensure the length of the optical path of the first light L1, the other first reflection mirror 227 is disposed adjacently to the one first reflection mirror 226 and is configured to be longer than the one first reflection mirror 226 but shorter than the second reflection mirror 228.

Additionally, being disposed at substantially the same distance from the second polygonal mirror 233 and from the x-axis, respectively, the third and the fourth reflection mirrors 235 and 237 have substantially the same length.

As described above, interference between the second and the third lights L2 and L3 may be substantially prevented by disposing the respective polygonal mirrors 223 and 233 at different heights from the image carrying mediums, that is, at different distances from the x-axis. Accordingly, the interval between the polygonal mirror 223 and 233 may be reduced by omitting a partition therebetween. Also, the respective image carrying mediums 131 through 134 are alternately positioned in pairs of 131 with 133 and 132 with 134 and may be scanned with the lights using the polygonal mirrors 223 and 233. Thus, by reducing the intervals among the image carrying mediums 131 through 134, while keeping uniformity of the intervals, the image forming apparatus may be implemented in a compact size.

Furthermore, by disposing one of the first and the second driving motors 212 and 214 upside down, the polygonal mirrors 223 and 233 may be disposed at different positions, thereby minimizing the thickness of the laser scan unit 200.

However, when the height of the image forming apparatus or the thickness of the laser scan unit 200 do not actually matter, in other words, compactness of the image forming apparatus is not considered important, the two driving motors 212 and 214 may be disposed in the same directions at different heights unlike as shown in FIG. 3.

As may be appreciated from the above description of the laser scan unit 200 and the image forming apparatus having the same, according to an exemplary embodiment of the present invention, interference among the lights L1 through L4 deflected by the polygonal mirrors 223 and 233 may be substantially prevented by disposing the plurality of polygonal mirrors 223 and 233 for scanning the image carrying mediums 131 through 134 with the lights L1 through L4 at different distances from the image carrying mediums 131 through 134.

Accordingly, the partition is not required between the polygonal mirrors 223 and 233, thereby saving the mounting space for the polygonal mirrors 223 and 233. Thus, disposition of the optical guides G1 through G4 may be flexible, thereby saving the mounting space for the image carrying mediums 131 through 134.

Consequently, the whole size of the laser scan unit 200 and the image forming apparatus having the same may be reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A laser scan unit for projecting lights to first through fourth sequentially disposed image carrying mediums, comprising:
a first deflection scanning optical system deflects a first plurality of incident lights in respectively different directions toward the first and the third image carrying mediums; and
a second deflection scanning optical system deflects a second plurality of incident lights in respectively different directions toward the second and the fourth image carrying mediums,
the first and the second deflection scanning optical systems disposed at different distances with respect to a reference axis substantially perpendicular to a direction in which the first and second plurality of lights are projected to the respective image carrying mediums.

2. The laser scan unit of claim 1, wherein the first deflection scanning optical system includes
first and second light sources projecting first and second lights, respectively;
a first polygonal mirror deflecting the first and the second lights in different directions;
a first driving motor rotating the first polygonal mirror;
a first optical guide guiding the first light deflected from the first polygonal mirror toward the first image carrying medium; and
a second optical guide guiding the second light deflected from the first polygonal mirror toward the third image carrying medium.

3. The laser scan unit of claim 2, wherein the first optical guide includes
a first f·θ lens mounted on an optical path between the first polygonal mirror and the first image carrying medium; and
a plurality of first reflection mirrors mounted on an optical path between the first f·θ lens and the first image carrying medium.

4. The laser scan unit of claim 3, wherein the plurality of first reflection mirrors include
two first reflection mirrors, one first reflection mirror being disposed at substantially the same distance as the first f·θ lens and the first polygonal mirror with respect to the reference axis, and the other first reflection mirror being disposed at a distance further than the one first reflection mirror with respect to the reference axis.

5. The laser scan unit of claim 2, wherein the second optical guide includes
a second f·θ lens mounted on an optical path between the first polygonal mirror and the third image carrying medium; and
a second reflection mirror mounted on an optical path between the second f 0 lens and the third image carrying medium.

6. The laser scan unit of claim 1, wherein the second deflection scanning optical system includes
third and fourth light sources projecting third and fourth lights;
a second polygonal mirror deflecting the third and the fourth lights in different directions;
a second driving motor rotating the second polygonal mirror;
a third optical guide guiding the third light deflected from the second polygonal mirror toward the second image carrying medium; and
a fourth optical guide guiding the fourth light deflected from the second polygonal mirror toward the fourth image carrying medium.

7. The laser scan unit of claim 6, wherein the third optical guide includes
a third f·θ lens mounted on an optical path between the second polygonal mirror and the second image carrying medium; and
a third reflection mirror mounted on an optical path between the third f·θ lens and the second image carrying medium.

8. The laser scan unit of claim 6, wherein the fourth optical guide includes
a fourth f·θ lens mounted on an optical path between the second polygonal mirror and the fourth image carrying medium; and
a fourth reflection mirror mounted on an optical path between the fourth f·θ lens and the fourth image carrying medium.

9. The laser scan unit of claim 6, wherein
the first and the second optical guides are disposed at substantially the same distance from the reference axis.

10. The laser scan unit of claim 2, wherein the second deflection scanning optical system includes
third and fourth light sources projecting third and fourth lights;
a second polygonal mirror deflecting the third and the fourth lights in different directions;
a second driving motor rotating the second polygonal mirror;
a third optical guide guiding the third light deflected from the second polygonal mirror toward the second image carrying medium; and
a fourth optical guide guiding the fourth light deflected from the second polygonal mirror toward the fourth image carrying medium.

11. The laser scan unit of claim 10, wherein
the third and the fourth optical guides are disposed at different distances from the first and the second optical guides with respect to the reference axis.

12. The laser scan unit of claim 11, wherein
the third and the fourth optical guides are disposed further from the reference axis than the first and the second optical guides.

13. The laser scan unit of claim 10, wherein
the first and the second driving motors are disposed at different distances from the reference axis.

14. The laser scan unit of claim 13, wherein
the first and the second driving motors are symmetrically disposed approximately 180° apart.

15. The laser scan unit of claim 1, wherein
the first through the fourth image carrying mediums are arranged with substantially uniform intervals therebetween.

16. The laser scan unit of claim 1, wherein
the first deflection scanning optical system is disposed closer to the reference axis than the second deflection scanning optical system.

17. An image forming apparatus, comprising:
first to fourth image carrying mediums sequentially disposed parallel with a predetermined reference axis; and
a laser scan unit projecting lights to the first through the fourth image carrying mediums in a direction substantially perpendicular to the reference axis, respectively,
wherein the laser scan unit includes
a first deflection scanning optical system deflecting reflecting a first plurality of incident lights in respectively different directions toward the first and the third image carrying mediums;
a second deflection scanning optical system deflecting a plurality of incident lights in respectively different directions toward the second and the fourth image carrying mediums; and
the first and the second deflection scanning optical systems disposed at different distances with respect to a reference axis substantially perpendicular to a direction in which the first and second plurality of lights are projected to the respective image carrying mediums.

18. The image forming apparatus of claim 17, wherein the first deflection scanning optical system includes
first and second light sources projecting first and second lights, respectively;
a first polygonal mirror deflecting the first and the second lights in different directions;
a first driving motor rotating the first polygonal mirror;
a first optical guide guiding the first light deflected from the first polygonal mirror toward the first image carrying medium; and
a second optical guide guiding the second light deflected from the first polygonal mirror toward the third image carrying medium.

19. The image forming apparatus of claim 18, wherein the first optical guide includes
a first f·θ lens mounted on an optical path between the first polygonal mirror and the first image carrying medium; and
a plurality of first reflection mirrors mounted on an optical path between the first f·θ lens and the first image carrying medium.

20. The image forming apparatus of claim 19, wherein the plurality of first reflection mirrors includes
two first reflection mirrors, one first reflection mirror being disposed at substantially the same distance as the first f·θ lens and the first polygonal mirror with respect to the reference axis; and the other first reflection mirror being disposed at a distance further than the one first reflection mirror with respect to the reference axis.

21. The image forming apparatus of claim 18, wherein the second optical guide includes
a second f·θ lens mounted on an optical path between the first polygonal mirror and the third image carrying medium; and
a second reflection mirror mounted on an optical path between the second f·θ lens and the third image carrying medium.

22. The image forming apparatus of claim 17, wherein the second deflection scanning optical system includes
third and fourth light sources projecting third and fourth lights;
a second polygonal mirror deflecting the third and the fourth lights in different directions;
a second driving motor rotating the second polygonal mirror;
a third optical guide guiding the third light deflected from the second polygonal mirror toward the second image carrying medium; and
a fourth optical guide guiding the fourth light deflected from the second polygonal mirror toward the fourth image carrying medium.

23. The image forming apparatus of claim 22, wherein the third optical guide includes
a third f·θ lens mounted on an optical path between the second polygonal mirror and the second image carrying medium; and
a third reflection mirror mounted on an optical path between the third f·θ lens and the second image carrying medium.

24. The image forming apparatus of claim 22, wherein the fourth optical guide includes
a fourth f·θ lens mounted on an optical path between the second polygonal mirror and the fourth image carrying medium; and
a fourth reflection mirror mounted on an optical path between the fourth f·θ lens and the fourth image carrying medium.

25. The image forming apparatus of claim 22, wherein
the first and the second optical guides are disposed at substantially the same distance from the reference axis.

26. The image forming apparatus of claim 18, wherein the second deflection scanning optical system includes
third and fourth light sources projecting third and fourth lights;
a second polygonal mirror deflecting the third and the fourth lights in different directions;
a second driving motor rotating the second polygonal mirror;
a third optical guide guiding the third light deflected from the second polygonal mirror toward the second image carrying medium; and
a fourth optical guide guiding the fourth light deflected from the second polygonal mirror toward the fourth image carrying medium.

27. The image forming apparatus of claim 26, wherein
the third and the fourth optical guides are disposed at different distances from the first and the second optical guides with respect to the reference axis.

28. The image forming apparatus of claim 27, wherein
the third and the fourth optical guides are disposed further from the reference axis than the first and the second optical guides.

29. The image forming apparatus of claim 28, wherein
the first and the second driving motors are symmetrically disposed approximately 180° apart.

30. The image forming apparatus of claim 17, wherein
the first through the fourth image carrying mediums are disposed with substantially uniform intervals therebetween.

31. The image forming apparatus of claim 17, wherein
the first deflection scanning optical system is disposed closer to the reference axis than the second deflection scanning optical system.
